(19) United States
(12) Patent Application Publication
(10) Pub. No.: US 2007/0245505 A1
(43) Pub. Date: Oct. 25, 2007

(54) Disc Cleaner

(76) Inventors: Tony J. Abfall, Mount Prospect, IL (US); Paul R. Holbrook, Buffalo Grove, IL (US); Stephen J. Kohler, Evanston, IL (US); Sigurd A. Nelson ll, Evanston, IL (US); David M. Waskin, Arlington Heights, IL (US)

Correspondence Address: MICHAEL BEST & FRIEDRICH LLP, Two Prudential Plaza, 180 North Stetson Avenue, Suite 2000, CHICAGO, IL, 60601, US

(21) Appl. No.: 10/567,278

(22) PCT Filed: Feb. 14, 2005
(86) PCT No.: PCT/US05/04433

§ 371 Date: Feb. 3, 2006

Related U.S. Application Data
(60) Provisional application No. 60/544,803, filed on Feb. 13, 2004.

(51) Int. Cl. G11B 3/58

(52) U.S. Cl. 15/102; 15/97.1

(57) ABSTRACT

A disc cleaner (10) for cleaning discs (D), which in some aspects can clean vertically oriented discs. The disc cleaner may include a housing (20) for supporting a disc, a drive assembly supported by the housing and engageable with the disc to rotate the disc, and means for applying cleaning agent (B) to a data recording surface of the disc (R) while the disc is supported by the housing. The disc cleaner may include housing that facilitates handling of the disc by its central hole, a drive assembly disposed within the housing, the drive assembly frictionally rotating the disc by its perimeter, and a switch (75) for actuating the drive assembly when the disc is at least partially inserted in the housing.

### RELATED APPLICATION

The present application claims the benefit of co-pending U.S. Provisional Patent Application No. 60/544,803, filed Feb. 13, 2004, the entire contents of which is hereby incorporated by reference.

### BACKGROUND

Optical discs such as compact discs (CD), digital video discs (DVD) and other discs for computers (e.g., CD-ROM, CD-R, CD-RW, DVD-RW, etc.) and video game systems (e.g., Xbox™, Playstation™, GameCube™, etc.) are direct access storage devices that are written and read by laser light. Optical disc storage capacity is far greater than that for magnetic media, however, optical disc readers are more sensitive to media imperfections such as scratches, surface dust, dirt, fingerprints, smudges, and the like. Such permanent and removable media imperfections may cause the laser light to reflect and/or refract, thereby corrupting the read data. Therefore, regular maintenance of optical discs is needed to ensure data readability.

Optical disc cleaning, in its simplest form is performed by manually wiping the disc with a clean, soft fabric to remove surface dirt. In certain instances, prior to manually wiping the disc, a cleaning agent (e.g., alcohol, surfactant, etc.) may be manually sprayed or otherwise applied to the disc surface to facilitate removal of removable imperfections. Alternatively, a number of mechanical disc cleaners are available. These mechanical disc cleaners typically include a clamshell shaped housing with a turntable disposed therein. The disc is placed horizontally on the turntable and is rotated for cleaning. The turntable may be hand operated by a crank and gear mechanism, or may be motorized. Use of such mechanical disc cleaners is somewhat disadvantageous for a number of reasons.

One disadvantage is that the top of the clamshell housing typically includes at least a portion of the crank and gear mechanism for rotating the disc. Therefore, the user must open the clamshell housing to determine if the disc is substantially clean. The user may not monitor the cleaning process. Additionally, the user may not apply a cleaning agent to the disc surface as it is being rotated. Another significant disadvantage to such mechanical turntable-style disc cleaners is that it can be difficult to insert and remove a disc from the cleaner. Often, such cleaners require that the user handle the disc about its perimeter after cleaning is completed. Handling the disc in this manner may be difficult if the user has small hands or lacks hand strength and/or flexibility. Certainly, it is easier to handle a disc about its center hole by inserting a finger therethrough, however, if the disc is installed on a turntable with a spindle, this is not possible.

In view of the foregoing, there is a need for an optical disc cleaner that accepts a vertically oriented disc. Moreover, the disc cleaner should be compact, portable, easy and fun to use.

### BRIEF SUMMARY

In some aspects, a disc cleaner is provided and includes a housing defining a slot, a disc being at least partially insertable into the slot and supportable by the housing in a vertical orientation, a drive assembly positioned within the housing and engageable with the disc to rotate the disc, and a switch for actuating the drive assembly when the disc is at least partially inserted into the slot.

In some aspects, a disc cleaner is provided for cleaning a disc having a data reading surface that is readable by an electrical component, the disc cleaner including a housing for the supporting the disc, a drive assembly supported by the housing and engageable with the disc to rotate the disc, and means for retaining and providing a cleaning agent, wherein cleaning agent is applicable to the data reading surface of the disc while the disc is supported by the housing.

In some aspects, a disc cleaner for cleaning a vertically oriented disc is provided and includes a housing that facilitates handling of the disc by its central hole, a drive assembly disposed within the housing, the drive assembly frictionally rotating the disc by its perimeter, and a switch for actuating the drive assembly when the disc is at least partially inserted in the housing.

### BRIEF DESCRIPTION OF THE DRAWINGS

FIG. 1 is a top perspective view of a disc cleaner.

FIG. 2 is a front elevation view of the disc cleaner shown in FIG. 1.

FIG. 3 is a side elevation view of the disc cleaner shown in FIG. 1.

FIG. 4 is a top view of the disc cleaner shown in FIG. 1.

FIG. 5A is a front exploded view of the disc cleaner shown in FIG. 1.

FIG. 5B is a rear exploded view of the disc cleaner shown in FIG. 1.

Before at least one embodiment of the invention is explained in detail, it is to be understood that the invention is not limited in its application to the details of construction and the arrangements of the components set forth in the following description or illustrated in the drawings. The invention is capable of other embodiments and of being practiced or being carried out in various ways.

### DETAILED DESCRIPTION

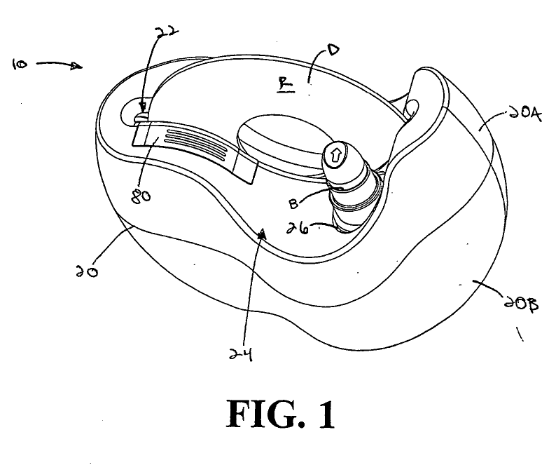

Referring now to the Figures and particularly FIG. 1, a vertical disc cleaner 10 is shown. The cleaner 10 includes a shaped housing 20, which may be constructed of any suitable material known in the art, but preferably the housing 20 is constructed of a molded or formed plastic material. The housing 20 may be constructed of one or more pieces to facilitate manufacturing and/or assembly. As illustrated, the housing 20 includes an upper portion 20A and a base portion 20B. The housing 20 may include an external matte finish that provides a non-slip surface for improved gripping of the cleaner 10 during transportation.

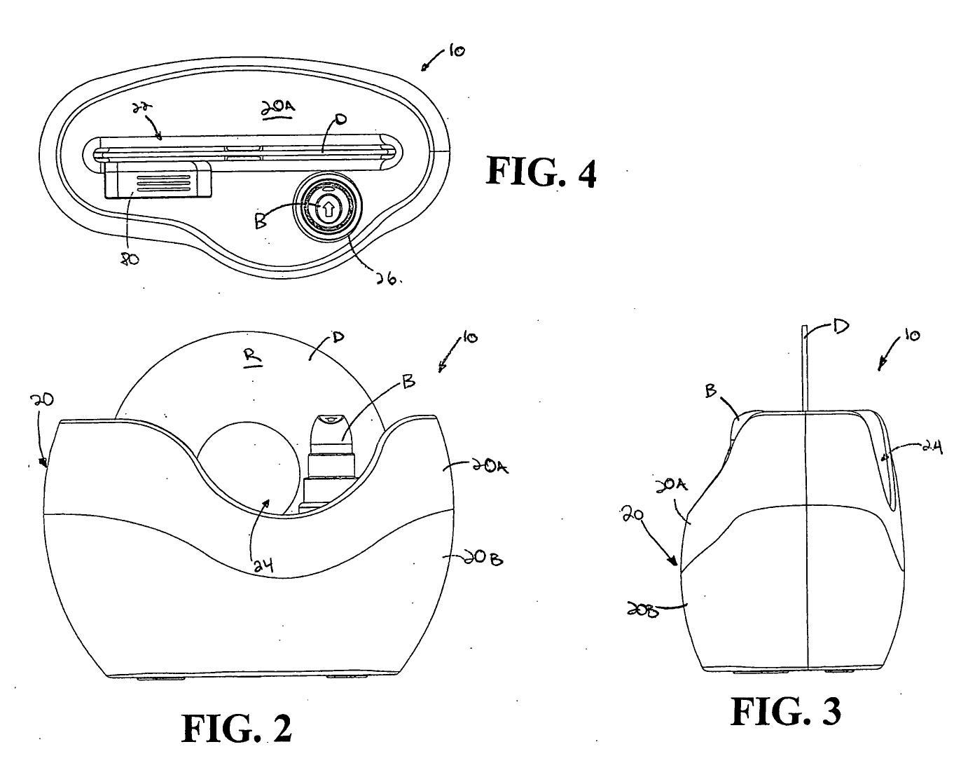

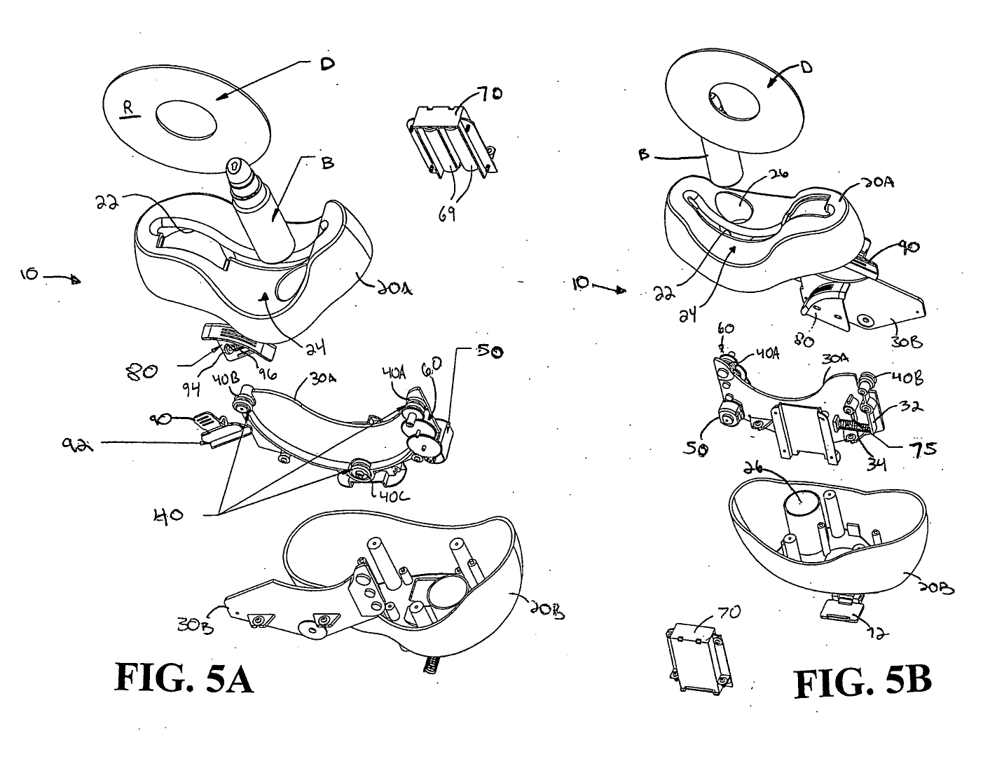

The housing 20 is substantially hollow (FIG. 5A, 5B), and the interior houses a number of components hereafter discussed in further detail. The upper portion 20A includes an elongated slot 22 for accepting a portion of an optical disc D. The disc D, which is planar and toroidal in shape, has a circular perimeter, a reading surface R and a central hole. As known in the art, the housing 20 may include one or more “lead-ins” (not shown) proximate the slot 22 so that the disc D may be properly guided and aligned with the cleaner's internal components, such as the rollers and wiper pad (discussed in further detail hereafter), during insertion, thereby obviating damage to the disc D and the device 10. In addition, the edges of the slot 22 may be chamfered, curved, or otherwise shaped to make a smooth transition into the cleaner's interior so that the disc D does not become scratched, scuffed, or otherwise damaged during insertion and removal. The upper surface of the upper portion 20A of the housing 20 includes a depressed portion 24, which is somewhat u-shaped. As shown in FIG. 2, the lowest point of the depressed portion 24 is proximate the midpoint of the slot 22, and the depressed portion 24 substantially coincides with the central hole of the disc D.

As illustrated in FIGS. 1-4, the upper portion 20A includes a well 26 that is sized and shaped to accept a bottle B. The bottle B may be either integral with the well 26 or removable. Additionally, an integral bottle may be refillable and a removable bottle B may be disposable or refillable. The bottle B may be an atomizer or spray bottle for applying a cleaning agent onto the reading surface R of the disc D. The cleaning agent may be an alcohol such as isopropyl alcohol, a surfactant, or other liquid for facilitating cleaning of the disc D. The well 26 may be sized and shaped to accept a particular bottle B. Moreover, the well 26 and/or bottle B may include an anti-piracy element such that the well 26 only accepts bottles of the same size and shape as bottle B. Furthermore, the well 26 and bottle B may cooperate with each other such that the bottle B is properly oriented (i.e., to apply the cleaning agent on the reading surface R of the disc D). As shown in FIGS. 1, 2, 4 and 5A, the bottle B is properly oriented when the illustrated arrow on the bottle's pump head points toward the disc D.

Referring now to FIGS. 5A and 5B, the internal components of the vertical disc cleaner 10 are described in detail. As shown, a cleaning chamber accepts a portion of disc D and includes a first portion 30A and a second portion 30B. The first and second portions 30A, 30B of the cleaning chamber extend downward from the slot 22 and are spaced apart by a width corresponding to the width of the slot 22. When the portions 30A, 30B are affixed to each other, the bottom of the chamber is sealed, thereby inhibiting cleaning agent from entering the housing interior. As shown in FIG. 5A, the first portion 30A includes a number of posts or bosses that rotatably retain rollers 40 and a gear arrangement 60. The rollers 40 and gear arrangement 60 are fixed on their respective posts or bosses when the portions 30A, 30B are affixed to each other.

The rollers 40 are channeled having u-shaped or v-shaped channels along their perimeters. The channels of the rollers 40 define a plane for retaining a disc D. The rollers 40 are preferably made of a rubber or other elastomeric material such as silicone or neoprene for frictionally engaging the perimeter of a disc. Preferably, the rollers 40 do not slip against the disc perimeter; do not leave a residue on the disc, and do not scratch, mar, or wear on the disc. As illustrated, the cleaner 10 includes three rollers 40, however, fewer or additional rollers 40 may be employed. The roller 40 proximate the gear arrangement 60 is hereafter referred to as the driving roller 40A. The driving roller 40A is coupled to the gear arrangement 60 and rotates to frictionally drive the disc D. The illustrated gear arrangement 60 includes three spur gears that couple the driving roller 40A to a motor 50 and drive the disc D at a rate of approximately 10 RPM. Alternatively, other gear arrangements having more or fewer gears may be used and the disc D may be driven at other rates and still be within the spirit and scope of the present invention. The motor 50 may be a toy-grade or other suitable motor as known in the art. One exemplary motor is a 3V motor powered by two (2) AA batteries, the motor shaft turning at approximately 3000 RPM when loaded. Alternatively, other amounts and powers of batteries can be used, such as, for example (4) AAA batteries.

Opposite the driving roller 40A is a roller 40 hereafter referred to as a switch roller 40B. As shown in FIG. 5B, the switch roller 40B is affixed to the upper end of a lever arm 32. The lever arm 32 is pivoted at a pivot point intermediate its upper and lower ends. The lower end of the lever arm 32 is normally biased outward by spring 34. Consequently, the switch roller 40B is biased slightly toward the driving roller 40A. Electrical switch contacts 75 are disposed proximate the lever arm 32 and spring 34. The switch contacts 75 may be part of a microswitch or other switch means (not shown) and are in a normally open state. When the switch contacts 75 are closed, a series circuit is completed, thereby connecting a power source to the motor 50. As illustrated in FIGS. 5A and 5B, the exemplary power source is a pair of AA batteries 69 within battery chamber 70. The batteries 69 are accessible and replaceable via battery door 72 (FIG. 5B). Preferably, the motor 50 is powered by a direct current source, such as disposable or rechargeable batteries, however, the cleaner 10 may alternatively be powered directly by an alternating current source, or by an AC to DC adapter which is plugged into the cleaner 10 and a power outlet.

With the switch roller 40B in its normally biased position, the distance between the channels of the switch roller 40B and the driving roller 40A is somewhat less than the diameter of disc D. As disc D is initially inserted into slot 22, the perimeter of the disc D contacts the switch roller 40B and driving roller 40A. As the disc D is inserted further (downward into the cleaning chamber), the disc D forces the switch roller 40B outward (i.e., away from the driving roller 40A). When the disc D is fully inserted into the cleaning chamber, the lowest portion of disc D contacts the roller 40 intermediate the switch roller 40B and the driving roller 40A, hereafter referred to as the stop roller 40C. The stop roller 40C is positioned to prevent the disc D from contacting the bottom of the cleaning chamber. As the disc D contacts the stop roller 40C, the diameter of the disc D forces the switch roller 40B maximally outward such that the switch contacts 75 are closed and the motor 50 is actuated. The motor 50 may run continuously until the disc D is removed, or alternatively, the cleaner 10 may include a timing circuit, whereby after the cleaner 10 runs for a predetermined period of time (e.g., forty five seconds), the motor 50 will turn off automatically. The exemplary cleaner 10 will operate many times before having to replace the batteries. Additionally, the exemplary cleaner 10 will preferably operate continuously for at least 30 minutes before substantially draining the batteries (e.g., “drained” may be defined as when the disc rotates slower than 8 RPM). In other alternative embodiments, the cleaner 10 may include an integrated circuit (IC) for controlling the motor 50. Furthermore, the cleaner 10 may include one or more sensors in communication with the IC for detecting the condition of the inserted disc D. The one or more sensors may include a moisture sensor for detecting the level of moisture (i.e., cleaning agent) on the disc D, an optical sensor for detecting particulate matter on the disc D, or other sensors or combination of sensors known in the art. Additionally, the cleaner 10 may include an ejection means (like the spring ejection means of a toaster) for facilitating removal of an inserted disc D. Alternatively, a small reverse current can be sent to the motor 50 at an end of a cleaning cycle so that the disc D is driven backward out of the slot until the disc D disengages the switch roller 40B.

As the disc D is rotated within the cleaning chamber, a wiper arm 90 is urged against the disc read surface R (FIGS. 5A and 5B). The wiper arm 90 includes a soft, absorbent wiper pad 92 made of fabric, foam, or other suitable material that will not scratch, scuff, mar, or otherwise damage the disc read surface R, and is capable of absorbing liquid such as the cleaning agent. The wiper pad 92 is preferably as long as the distance from the perimeter of the disc D to its central hole such that the disc D does not catch or snag the edges of the pad 92. One exemplary wiper pad is approximately 0.35 inches wide by 2.0 inches long. The wiper pad 92 may be permanently or removably affixed to the wiper arm 90. Moreover, the wiper arm 90 may include a “lead in” to prevent an inserted disc D from improperly contacting the wiper pad 92 and accidentally detaching the pad 92 from the arm 90. As shown in FIG. 5A, the arm 90 is oriented such that the wiper pad 92 contacts the bottom portion of disc D intermediate the switch roller 40B and stop roller 40C.

As shown in FIGS. 1 and 4, a cover 80 mates with the upper portion 20A of the housing 20. The cover 80 may be snap-fit or otherwise releasable attached to the upper portion 20A to provide access to the wiper arm 90 and pad 92. The top surface of the cover 80 may include a textured or gripping portion that facilitates removal of the cover 80 from the housing 20. As illustrated, the top surface of the exemplary cover 80 includes a number of elongated ridges. As best seen in FIG. 5A, the cover portion 80 engages the linear portion of the cleaning chamber's second portion 30B. The cover 80 includes a rod 94 with a spring 96 (see FIG. 5A) mounted thereon. The wiper arm 90 is attached to the cover 80 by way of the rod 94 and spring 96. The spring 96 may be a torsion spring or the like for biasing the wiper pad 92 inward (i.e., toward the read surface R of an inserted disc D). If the wiper pad 92 is removably affixed to the arm 90, the wiper arm 90 may be fixedly attached to the cover 80. Alternatively, if the wiper pad 92 is permanently affixed to the arm 90, the wiper arm 90 may be removably attached to the cover 80 and disposable when the pad 92 becomes worn or otherwise ineffective. In yet another alternative, the cover 80, arm 90, and pad 92 combination may be an integral and replaceable assembly.

Although particular constructions of the invention have been shown and described, other alternative constructions will be apparent to those skilled in the art and are within the intended scope of the present invention.

What is claimed is:

1. A disc cleaner comprising:
a housing defining a slot, a disc being at least partially insertable into the slot and supportable by the housing in a vertical orientation; and
a drive assembly at least partially positioned within the housing and engageable with the disc to rotate the disc in the vertical orientation.

2. The disc cleaner of claim 1, wherein the housing is configured to expose a portion of the disc, including a center hole of the disc, when the disc is supported by the housing, the disc capable of being handled for insertion into and removal from the slot by the center hole.

3. The disc cleaner of claim 1, wherein the drive assembly includes a plurality of rollers engageable with the disc and a motor coupled with at least one of the rollers to drive the at least one roller, the at least one driven roller operable to rotate the disc.

4. The disc cleaner of claim 1, further comprising a switch for actuating the drive assembly when the disc is at least partially inserted into the slot.

5. The disc cleaner of claim 4, wherein the switch is engageable by the disc when the disc is at least partially inserted into the slot.

6. The disc cleaner of claim 4, wherein the switch is coupled to the drive assembly and is activated when the disc engages the drive assembly.

7. The disc cleaner of claim 4, wherein the switch is a sensor and actuates the drive assembly when the presence of the disc is sensed within the slot.

8. A disc cleaner for cleaning a disc having a data reading surface that is readable by an electrical component, the disc cleaner comprising:
a housing for the supporting the disc;
a drive assembly supported by the housing and engageable with the disc to rotate the disc; and
means for retaining and providing a cleaning agent;
wherein cleaning agent is applicable to the data reading surface of the disc while the disc is supported by the housing.

9. The disc cleaner of claim 8, wherein the housing supports the disc in a vertical orientation.

10. The disc cleaner of claim 8, wherein the housing defines a slot into which the disc is partially insertable, a portion of the disc being exposed, including a center hole of the disc, when the disc is inserted into the slot and supported by the housing.

11. The disc cleaner of claim 10, wherein cleaning agent is applicable to the data reading surface of the exposed portion of the disc when the disc is inserted into the slot.

12. The disc cleaner of claim 8, further comprising a cleaning agent container connected to the housing and having cleaning agent therein, the cleaning agent container facing the disc in order to apply cleaning agent to the reading surface of the disc.

13. The disc cleaner of claim 12, wherein the housing defines a cavity and the cleaning agent container is removeably connected to the housing by inserting and removing the cleaning agent container into and from the cavity.

14. The disc cleaner of claim 12, wherein the cleaning agent container is permanently connected to the housing.

15. A disc cleaner for cleaning a vertically oriented disc, the disc cleaner comprising:
a housing that facilitates handling of the disc by its central hole;
a drive assembly disposed within the housing, the drive assembly frictionally rotating the disc by its perimeter; and
a switch for actuating the drive assembly when the disc is at least partially inserted in the housing.

16. The disc cleaner of claim 15, wherein the housing defines an elongated slot in a top surface thereof, the disc being at least partially insertable into the slot to be supported by the housing in a vertical orientation.

17. The disc cleaner of claim 16, wherein a portion of the vertically oriented disc, including the central hole, is exposed when the disc is supported by the housing.

18. The disc cleaner of claim 17, further comprising a cleaning agent container connected to the housing and having cleaning agent therein, the cleaning agent container being positioned to apply cleaning agent to the exposed portion of the vertically oriented disc.

19. The disc cleaner of claim 15, further comprising a wiper assembly for cleaning the vertically oriented disc.

20. The disc cleaner of claim 19, wherein the wiper assembly is releasably connected to the housing and includes a cover, a rod connected to the cover, a wiper arm, a wiper pad connected to the wiper arm and engageable with the disc, and a spring supported by the rod and operable to bias the wiper pad toward and into contact with the disc.

21. The disc cleaner of claim 15, wherein the drive assembly includes a plurality of rollers and a motor, each roller defines a channel for receiving and frictionally engaging the perimeter of the disc, wherein at least one of the rollers is coupled to and driven by the motor to rotate the vertically oriented disc.

22. The disc cleaner of claim 21, wherein one of the rollers is coupled to the switch to actuate the drive assembly when the disc engages the one of the rollers.
